(19) United States
(12) Patent Application Publication
(10) Pub. No.: US 2021/0174004 A1
(43) Pub. Date: Jun. 10, 2021

(54) METHODS AND SYSTEMS FOR DYNAMIC CUSTOMIZATION OF INDEPENDENT WEBPAGE SECTION TEMPLATES

(71) Applicant: Brad Sherp, Spring Hill, TN (US)

(72) Inventor: Brad Sherp, Spring Hill, TN (US)

(21) Appl. No.: 17/112,848

(22) Filed: Dec. 4, 2020

Related U.S. Application Data
(60) Provisional application No. 62/944,261, filed on Dec. 5, 2019.

(51) Int. Cl. G06F 40/14; H04L 29/08; G06F 3/0483; G06F 3/0484; G06F 40/186

(52) U.S. Cl. CPC G06F 40/14; H04L 67/36; G06F 40/186; G06F 3/04842; G06F 3/0483

(57) ABSTRACT

Various embodiments of an apparatus, methods, systems and computer program products described herein are directed to a Section Rendering Engine. The Section Rendering Engine presents to a user a plurality of selectable representations of one or more webpage section templates. The Section Rendering Engine receives from the user a selected representation of a desired webpage section template. The selected representation of the desired webpage section template is independent of a pre-defined webpage template. The Section Rendering Engine dynamically renders a portion of the webpage based on the desired webpage section template.

### CROSS-REFERENCE TO RELATED APPLICATIONS

This application claims the benefit of U.S. Provisional Application No. 62/944,261, filed Dec. 5, 2019, which is hereby incorporated by reference in its entirety.

### BACKGROUND

Conventional systems provide services for users to build web sites based on selection of the purpose of the website (e.g. personal, business, marketing). Based on the underlying purpose of the website, conventional systems offer various website and webpage templates that a user may select. A webpage template includes pre-defined functionality, text and sections that are all included together within the webpage template itself. Conventional webpage templates may allow for the user to provide desired display text and media to be included in a rendering of a selected webpage. Conventional webpage templates are often included within a set website hierarchy in which certain webpages are intended to be presented before other webpages. As such, some webpage templates include webpage sections that are dependent on data and input from webpage sections included in other webpage templates.

### SUMMARY

Various embodiments of an apparatus, methods, systems and computer program products described herein are directed to a Section Rendering Engine. The Section Rendering Engine provides functionality for a user to build a webpage(s) based on selection of a plurality independent webpage section templates. The user may insert user-defined data (e.g. text, images) into one or more fields of a desired webpage section template. The user's webpage may by based on multiple independent webpage section templates that are dynamically rendered and concurrently displayed according to a sort order selected by the user.

By building and rendering webpages based on user-selected webpage section templates, as opposed to requiring an initial selection of an overall webpage template, the Section Rendering Engine is a significant improvement over conventional systems by providing the user with flexibility in the customization, revision and storage of the corresponding webpages at the webpage section template level.

According to various embodiments, the Section Rendering Engine presents to a user a plurality of selectable representations of one or more webpage section templates. The Section Rendering Engine receives from the user a selected representation of a desired webpage section template. The Section Rendering Engine dynamically renders a portion of the webpage based on the desired webpage section template.

According to various embodiments, the selected representation of the desired webpage section template is independent of a pre-defined webpage template. For example, the user may select the desired webpage section template prior to selecting any template for a particular entire webpage. Each respective webpage section template is associated with a corresponding pre-defined object that includes webpage section code.

According to various embodiments, the Section Rendering Engine receives a request to access a webpage defined according to an account webpage data record stored in a database(s). In response to the request, the Section Rendering Engine renders the webpage section code of an account section data record for the desired webpage section template, whereby the account section data record is linked to the account webpage data record. The Section Rendering Engine displays the rendered webpage section code at a portion of the rendered webpage that is defined by the value of a sort order field in the account section data record for the desired webpage section template.

According to various embodiments, in response to receiving from the user a selected representation of a desired webpage section template, the Section Rendering Engine presents to the user a corresponding section editing user interface. The Section Rendering Engine receives user input at one or more fields of the section editing user interface. The Section Rendering Engine extracts one or more code sections and associated user input of the user editing interface. The Section Rendering Engine stores the one or more code sections and associated user input in a webpage section data record. The webpage section data record further includes a sort order field value selected by the user. The Section Rendering Engine links the webpage section data to a webpage account data record associated with the user.

The Section Rendering Engine accesses the webpage account data record associated with the user in response to a request to access the webpage. The Section Rendering Engine sequentially accesses a plurality of webpage section data records according to a respective sort order field value of each webpage section data record. For each accessed webpage section data record: the Section Rendering Engine retrieves one or more code sections and associated user input and inserts the retrieved code sections and associated user input into one or more portions of webpage section rendering code. The Section Rendering Engine executes the webpage section rendering code to render the corresponding webpage section at a user interface display location related to the sort order field value of the accessed webpage section data record. The Section Rendering Engine thereby dynamically builds and renders the user's webpage on a section-by-section basis based on the stored code portions and associated user input in the plurality of the webpage section data records.

Further areas of applicability of the present disclosure will become apparent from the detailed description, the claims and the drawings. The detailed description and specific examples are intended for illustration only and are not intended to limit the scope of the disclosure.

### BRIEF DESCRIPTION OF THE DRAWINGS

The present disclosure will become better understood from the detailed description and the drawings, wherein:

FIGS. 1A and 1B are each a diagram illustrating an exemplary environment in which some embodiments may operate.

FIGS. 2A and 2B are each a diagram illustrating an exemplary method that may be performed in some embodiments.

FIGS. 3A and 3B are each a diagram illustrating an exemplary environment in which some embodiments may operate.

FIG. 3C illustrates exemplary webpage code according to various embodiments.

FIG. 3D is a diagram illustrating an exemplary environment in which some embodiments may operate.

FIGS. 4A and 4B are each a diagram illustrating an exemplary environment in which some embodiments may operate.

FIG. 4C illustrates exemplary webpage code according to various embodiments.

FIGS. 5A and 5B are each a diagram illustrating an exemplary environment in which some embodiments may operate.

FIGS. 6A and 6B are each a diagram illustrating an exemplary environment in which some embodiments may operate.

FIG. 7 is a diagram of an exemplary user interface according to one or more embodiments.

### DETAILED DESCRIPTION

In this specification, reference is made in detail to specific embodiments of the invention. Some of the embodiments or their aspects are illustrated in the drawings.

For clarity in explanation, the invention has been described with reference to specific embodiments, however it should be understood that the invention is not limited to the described embodiments. On the contrary, the invention covers alternatives, modifications, and equivalents as may be included within its scope as defined by any patent claims. The following embodiments of the invention are set forth without any loss of generality to, and without imposing limitations on, the claimed invention. In the following description, specific details are set forth in order to provide a thorough understanding of the present invention. The present invention may be practiced without some or all of these specific details. In addition, well known features may not have been described in detail to avoid unnecessarily obscuring the invention.

In addition, it should be understood that steps of the exemplary methods set forth in this exemplary patent can be performed in different orders than the order presented in this specification. Furthermore, some steps of the exemplary methods may be performed in parallel rather than being performed sequentially. Also, the steps of the exemplary methods may be performed in a network environment in which some steps are performed by different computers in the networked environment.

Some embodiments are implemented by a computer system. A computer system may include a processor, a memory, and a non-transitory computer-readable medium. The memory and non-transitory medium may store instructions for performing methods and steps described herein.

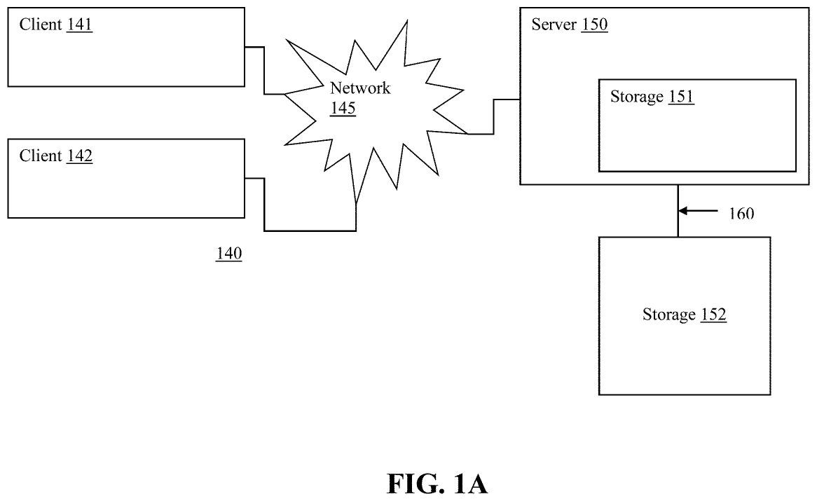

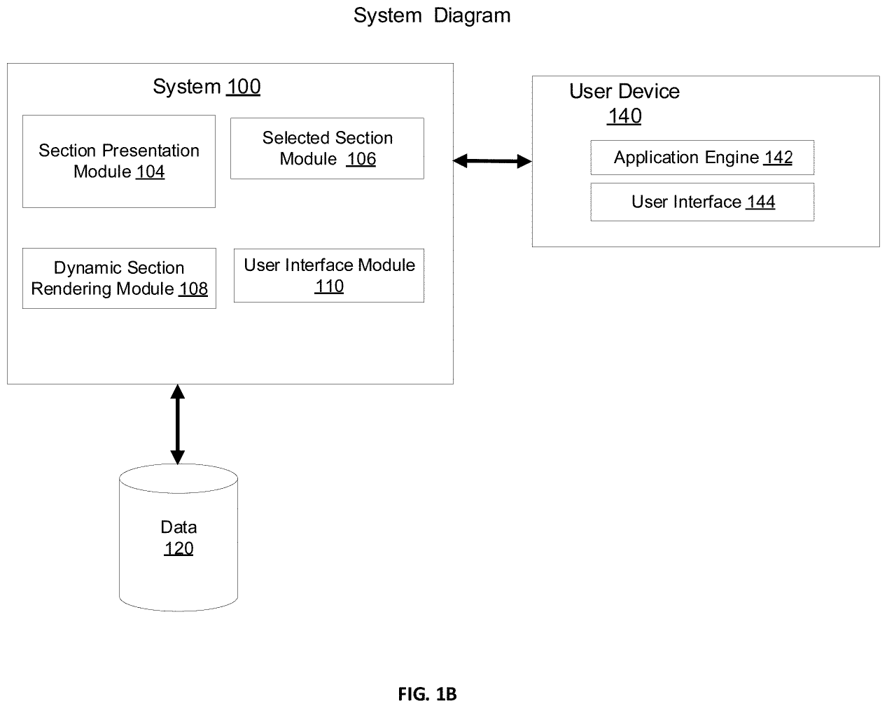

A diagram of exemplary network environment in which embodiments may operate is shown in FIG. 1A. In the exemplary environment 140, two clients 141, 142 are connected over a network 145 to a server 150 having local storage 151. Clients and servers in this environment may be computers. Server 150 may be configured to handle requests from clients.

The exemplary environment 140 is illustrated with only two clients and one server for simplicity, though in practice there may be more or fewer clients and servers. The computers have been termed clients and servers, though clients can also play the role of servers and servers can also play the role of clients. In some embodiments, the clients 141, 142 may communicate with each other as well as the servers. Also, the server 150 may communicate with other servers.

The network 145 may be, for example, local area network (LAN), wide area network (WAN), telephone networks, wireless networks, intranets, the Internet, or combinations of networks. The server 150 may be connected to storage 152 over a connection medium 160, which may be a bus, crossbar, network, or other interconnect. Storage 152 may be implemented as a network of multiple storage devices, though it is illustrated as a single entity. Storage 152 may be a file system, disk, database, or other storage.

In an embodiment, the client 141 may perform the method 200 or other method herein and, as a result, store a file in the storage 152. This may be accomplished via communication over the network 145 between the client 141 and server 150. For example, the client may communicate a request to the server 150 to store a file with a specified name in the storage 152. The server 150 may respond to the request and store the file with the specified name in the storage 152. The file to be saved may exist on the client 141 or may already exist in the server's local storage 151. In another embodiment, the server 150 may respond to requests and store the file with a specified name in the storage 151. The file to be saved may exist on the client 141 or may exist in other storage accessible via the network such as storage 152, or even in storage on the client 142 (e.g., in a peer-to-peer system).

In accordance with the above discussion, embodiments can be used to store a file on local storage such as a disk or on a removable medium like a flash drive, CD-R, or DVD-R. Furthermore, embodiments may be used to store a file on an external storage device connected to a computer over a connection medium such as a bus, crossbar, network, or other interconnect. In addition, embodiments can be used to store a file on a remote server or on a storage device accessible to the remote server.

Furthermore, cloud computing is another example where files are often stored on remote servers or remote storage systems. Cloud computing refers to pooled network resources that can be quickly provisioned so as to allow for easy scalability. Cloud computing can be used to provide software-as-a-service, platform-as-a-service, infrastructure-as-a-service, and similar features. In a cloud computing environment, a user may store a file in the “cloud,” which means that the file is stored on a remote network resource though the actual hardware storing the file may be opaque to the user.

FIG. 1B illustrates a block diagram of an example system 100 for a Section Rendering Engine that includes a section presentation module 104, a selected section module 106, a dynamic section rendering module 108 and a user interface (U.I.) module 110. The system 100 may communicate with a user device 140 to display output, via a user interface 144 generated by an application engine 142.

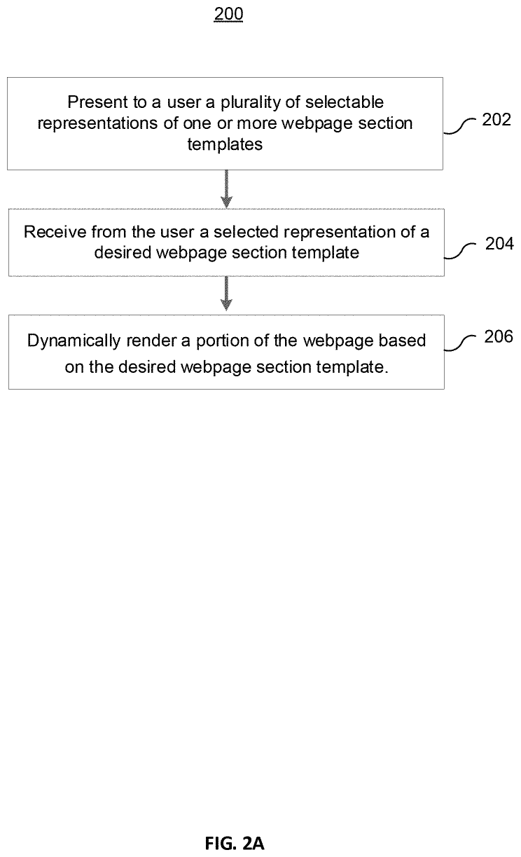

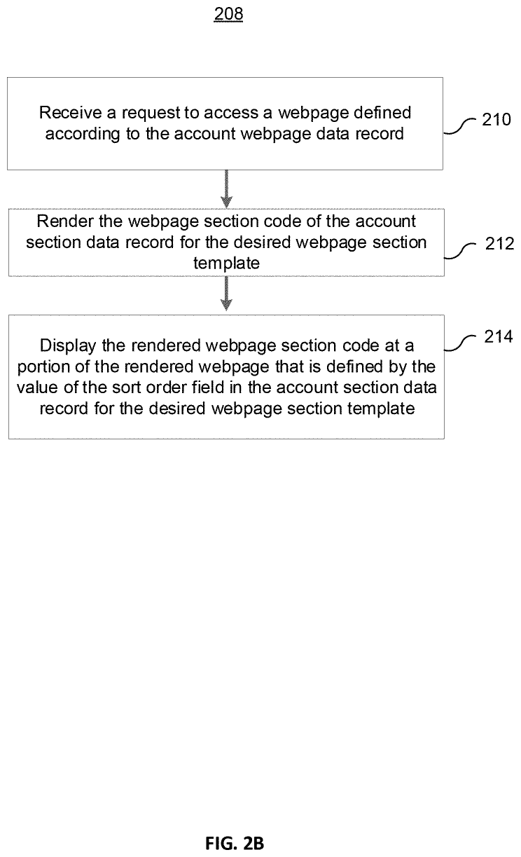

The section presentation module 104 of the system 100 may perform functionality as illustrated in FIGS. 2A, 2B, 3A, 3B, 3C, 3D, 4A, 4B, 4C, 5A, 5B, 6A and 6B.

The selected section module 106 of the system 100 may perform functionality as illustrated in FIGS. 2A, 2B, 3A, 3B, 3C, 3D, 4A, 4B, 4C, 5A, 5B, 6A and 6B.

The dynamic section rendering module 108 of the system 100 may perform functionality illustrated in 2A, 2B, 3A, 3B, 3C, 3D, 4A, 4B, 4C, 5A, 5B, 6A and 6B.

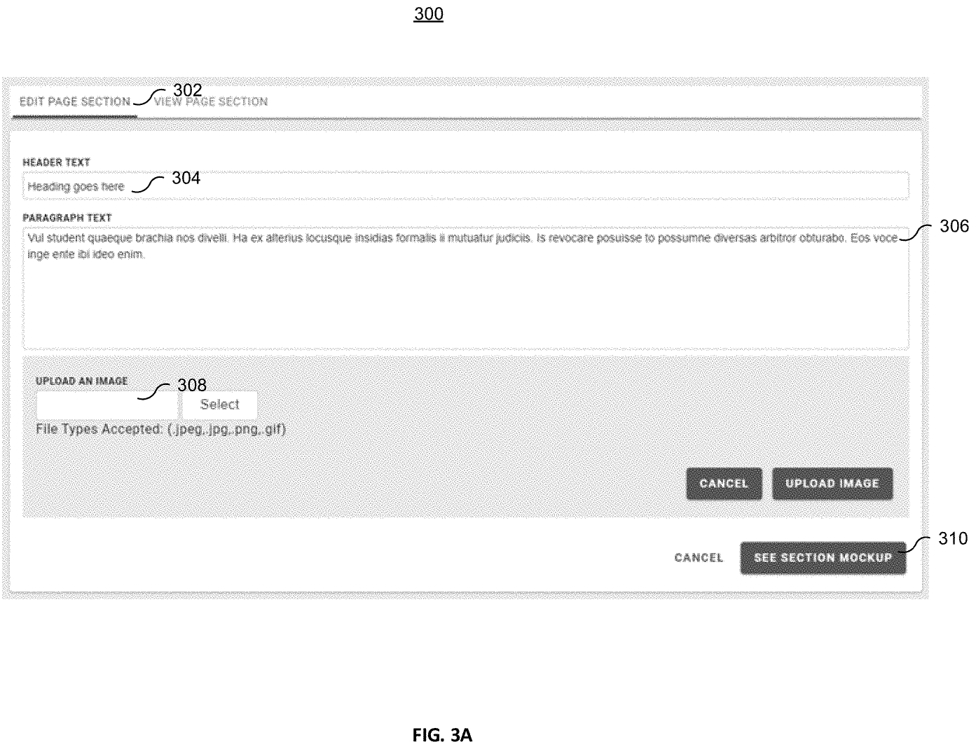

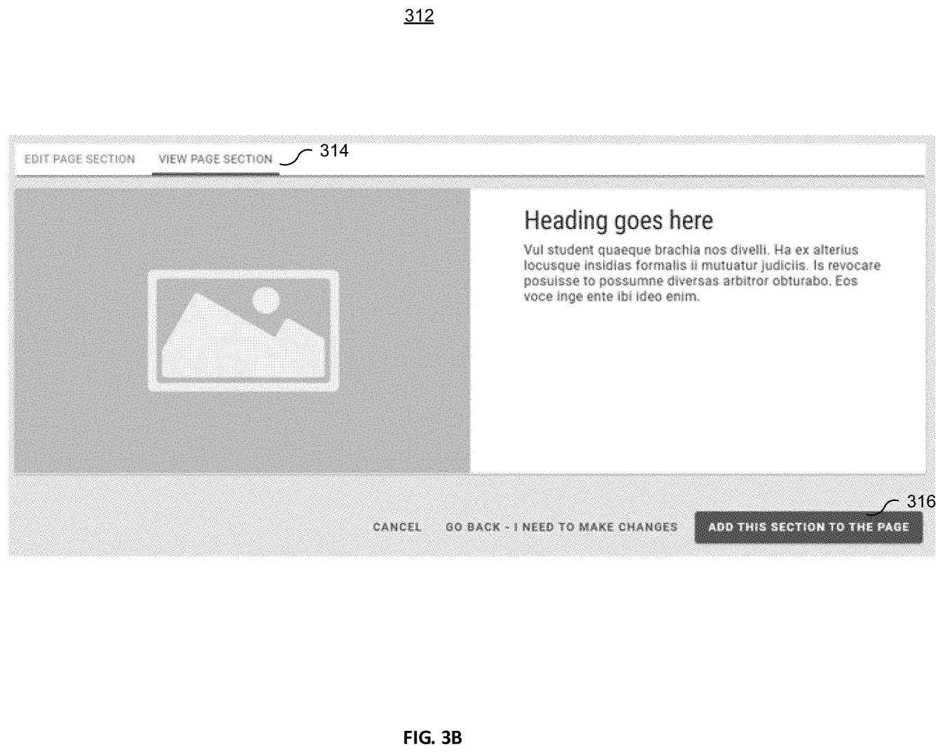

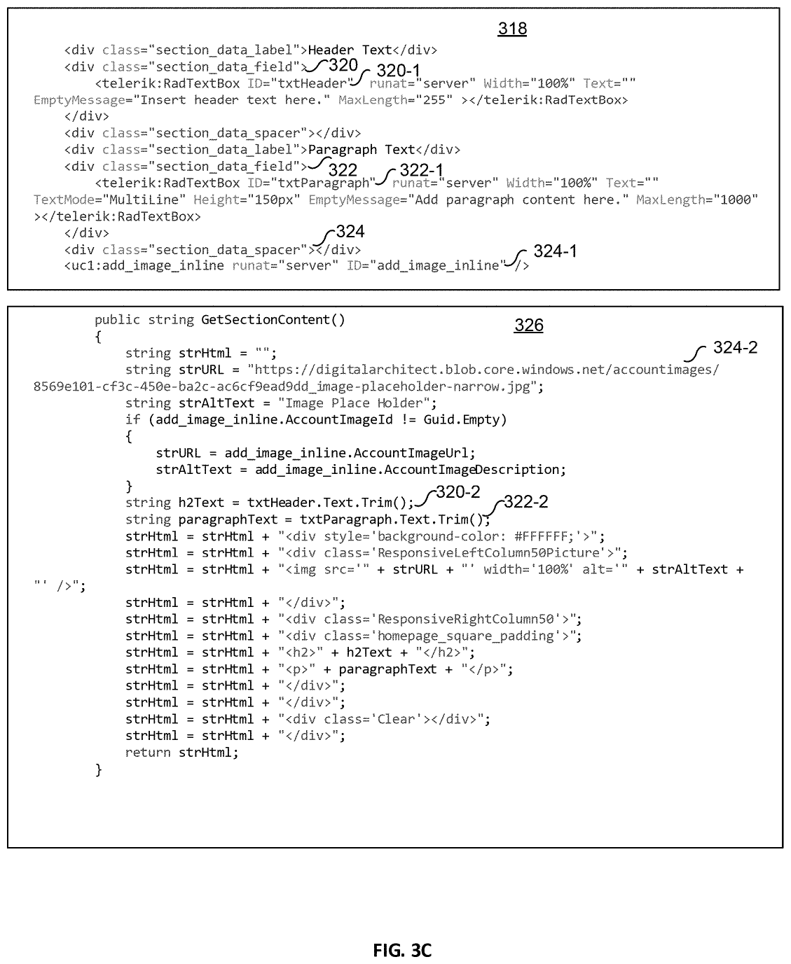

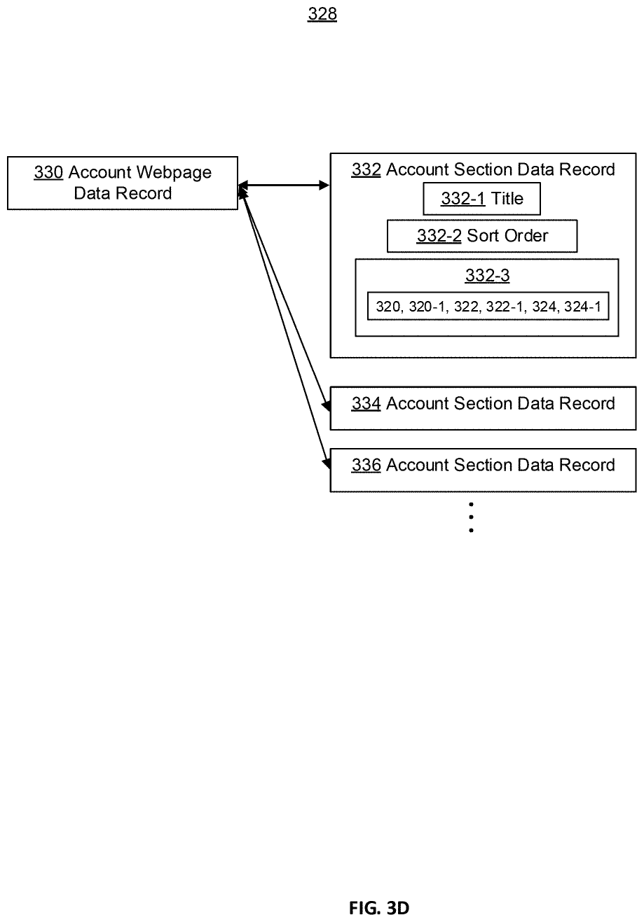

The user interface module 110 of the system 100 may display information based on functionality as illustrated in FIGS. 2A, 2B, 3C, 3D and 4C and may further display one or more user interfaces as illustrated in FIGS. 3A, 3B, 4A, 4B, 5A, 5B, 6A and 6B.

Data and information maintained in a database(s) 120 may be combined together or further separated in a manner the promotes retrieval and storage efficiency and/or data security.

As shown in the flowchart 200 of FIG. 2A, the Section Rendering Engine presents to a user a plurality of selectable representations of one or more webpage section templates (Act 202). According to various embodiments, each respective webpage section template is independent of any pre-defined webpage template. For example, many conventional systems provide a user with a gallery of selectable webpage templates, where each webpage template itself has one or more webpage sections that are specific to a corresponding webpage template. The webpage template sections provided to the user by the Section Rendering Engine are independent of any pre-define webpage template. The user may therefore ultimately customize a webpage project, through the selection and modification of various unrelated webpage section templates without being restricted by the structure and requirements of a 3^{rd}-party overall webpage template.

Each webpage section is associated with a corresponding pre-defined object that includes webpage section code. The webpage section code includes code for rendering the webpage section at a specific portion of a webpage. The webpage section code may include displayable text based on text inserted by the user and may further include one or more references to assets, such as an image(s), document(s), a video clip(s) and/or and audio file(s), that are to be included in a display of the rendered webpage section. For example, the reference may be a reference to a cloud storage location of one or more assets.

The Section Rendering Engine receives from the user a selected representation of a desired webpage section template (Act 204). According to various embodiments, in response to receiving the selected representation of a desired webpage section template, the Section Rendering Engine generates an account section data record for the desired webpage section template(s) selected by the user. For example, the Section Rendering Engine may be associated with one or more databases and/or one or more cloud storage locations. The user may have an account in the Section Rendering Engine that stores information regarding the user's selected webpage sections templates. The Section Rendering Engine generates account section data record for each of the user's selected webpage sections templates.

The Section Rendering Engine links the generated account section data record to the account webpage data record. Each account section data record for a desired webpage section template includes a section title field, a sort order field and the template's webpage section code that will be utilized to render that webpage section. According to various embodiments, the sort order field includes a value that indicates a display placement of the rendered desired webpage section template with respect to one or more concurrently displayed additional rendered webpage section templates. For example, if webpage section template's account data record has a sort order field has a value of “1”, then that webpage section template will be rendered by the Section Rendering Engine within a portion of a webpage that is defined as a display location for the sort order field value of “1”. The user may modify the sort order field value of any webpage section template account data record to update a display location of the corresponding rendered webpage section.

The Section Rendering Engine dynamically renders a portion of the webpage based on the desired webpage section template (Act 206). As shown in the flowchart 208 of FIG. 2B, the Section Rendering Engine receives a request to access a webpage defined according to the account webpage data record (Act 210). In response to the request, the Section Rendering Engine renders the webpage section code of the account section data record for the desired webpage section template (Act 212). For example, the Section Rendering Engine retrieves each webpage section template account data record linked to the requested webpage's account webpage data record. The Section Rendering Engine pulls respective webpage section code from each retrieved webpage section template account data record.

The Section Rendering Engine displays the rendered webpage section code at a portion of the rendered webpage that is defined by the value of the sort order field in the account section data record for the desired webpage section template (Act 214). According to various embodiments, the Section Rendering Engine executes the pulled webpage section code to concurrently display each rendered webpage section in the same webpage at various display locations defined by each retrieved webpage section template account data record sort ordered value.

As shown in the diagram 300 of FIG. 3A, the Section Rendering Engine displays a user interface for editing fields of a selected representation of a header webpage section. The user interface is displayed in response to user selection of an edit page section functionality 302. The user interface includes a header text field 304 in which the user can input text for a header of the webpage section. The user interface includes a paragraph text field 306 in which the user can input text for a paragraph of the webpage section. The user interface includes an image field 308 at which the user can provide a reference to a storage location of an image file. The Section Rendering Engine captures the input text and the image file reference and the Section Rendering Engine inserts the input text and the image file reference into one or more portions of header webpage section code of a pre-defined object for the header webpage section. The user interface includes a see section mockup functionality 310 that, upon selection, provides the user with a preview of a rendered version of the header webpage section.

As shown in the diagram 312 of FIG. 3B, the Section Rendering Engine displays a user interface that includes a preview of a rendered version of the header webpage section. The user interface is displayed in response to user selection of the see section mockup functionality 310 or a view page section functionality 314. Upon receipt of user selection of an add section functionality 316, the Section Rendering Engine generates an account section data record for the header webpage section and links the header webpage section's data record to the user's account webpage data record.

As shown in FIG. 3C, the Section Rendering Engine implements section editing code 318 for the section template editing user interface illustrated by FIG. 3A. For example, the section editing code 318 includes one or more code portions 320, 322, 324 for a pre-defined object that defines user-provided input to be included in a webpage header section. A code portion 320 represents a <div class> code portion at which the user will input header text and code portion 320-1 represents an identifier for the user provided header text. Another code portion 322 represents a <div class> code portion at which the user will input paragraph text and code portion 322-1 represents an identifier for the user provided paragraph text. Another code portion 324 represents a <div class> code portion at which the user will place an asset file name and code portion 324-1 represents an identifier for that asset file. The Section Rendering Engine extracts the code portions 320, 320-1, 322, 322-1, 324, 324-1 and stores the extracted code portions in a corresponding account webpage section data record.

As shown in FIG. 3C, the Section Rendering Engine implements rendering code 326 for the section rendering user interface illustrated by FIG. 3B. For example, Section Rendering Engine pulls the stores the extracted code portions 320, 320-1, 322, 322-1, 324, 324-1 from the corresponding account webpage section data record in order to render the header section via the rendering code 326. The Section Rendering Engine inserts the stored code portions via variables 320-2, 322-2, 324-2 of the rendering code 326 in order to render the header section according to the user input.

According to various embodiments, as shown in the diagram of 328 of FIG. 3D, the “<div class . . . > code sections and the received user input 320, 320-1, 322, 322-1, 324, 324-1 are extracted from the section editing code 318 by the Section Rendering Engine and stored in an account section data record 332 to reflect the header section template (in user interface 300 of FIG. 3A) as edited by the user. The account section data record 332 includes a title field 332-1, a sort order field 332-2 and the extracted code sections 332-3.

The Section Rendering Engine links the account section data record 332 to the user's account webpage data record 330, which represents the webpage the user wishes to build on a section-by-section basis. It is understood that the user's account webpage data record 330 may thereby be linked to multiple account section data records 334, 336 . . . wherein each respective linked account section data record 334, 336 . . . includes a sort order field value and stored extracted code sections that reflect further user input received at other various selected section template editing user interfaces.

In response to receiving a request to access the user's webpage, the Section Rendering Engine accesses the account webpage data record 330 and pulls and renders each linked account section data record 332, 334, 336 . . . according to each record's 332, 334, 336 . . . sort order field value. To render a respective webpage section, the Section Rendering Engine retrieves the stored extracted code portion(s) in the corresponding account webpage section record and inserts the retrieved code portions into various pre-defined locations in section rending code. The Section Rendering Engine thereby executes the section rendering code to render the webpage section. In order to render the section to be displayed at a webpage display location that corresponds to the rendered section's sort order field value. It is understood that the rendered webpage will include a concurrent display of multiple rendered webpage sections that are defined by the linked account section data records 332, 334, 336.

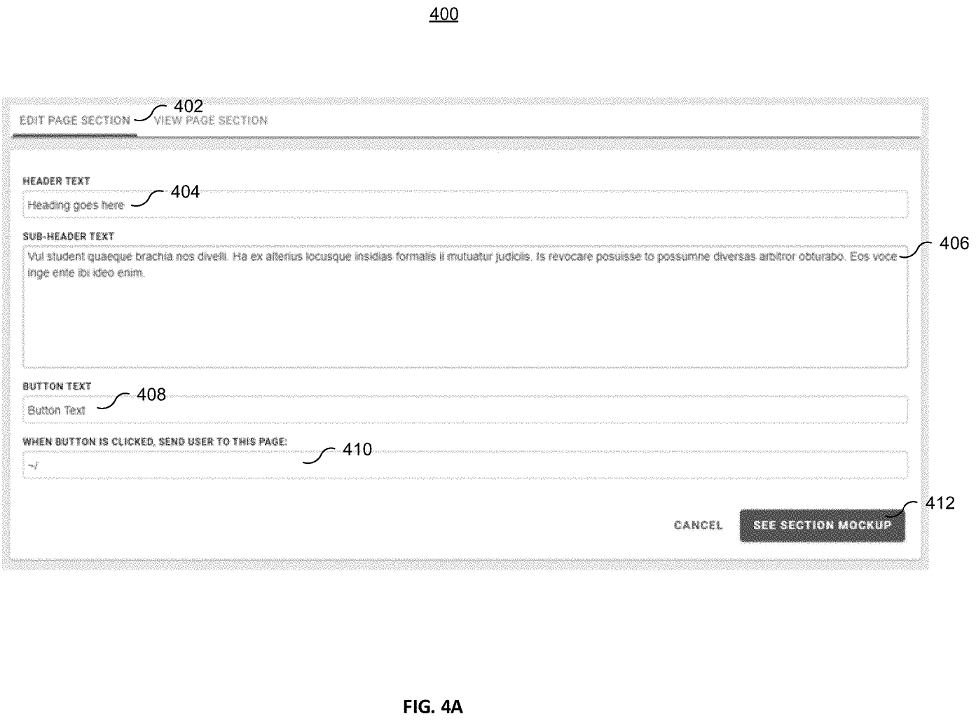

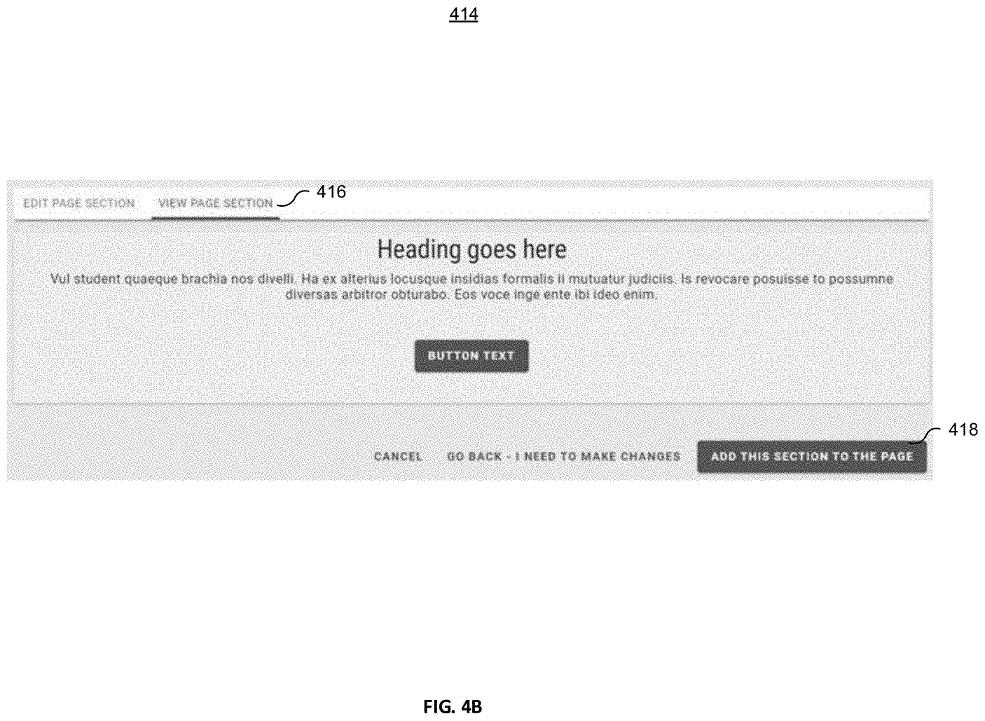

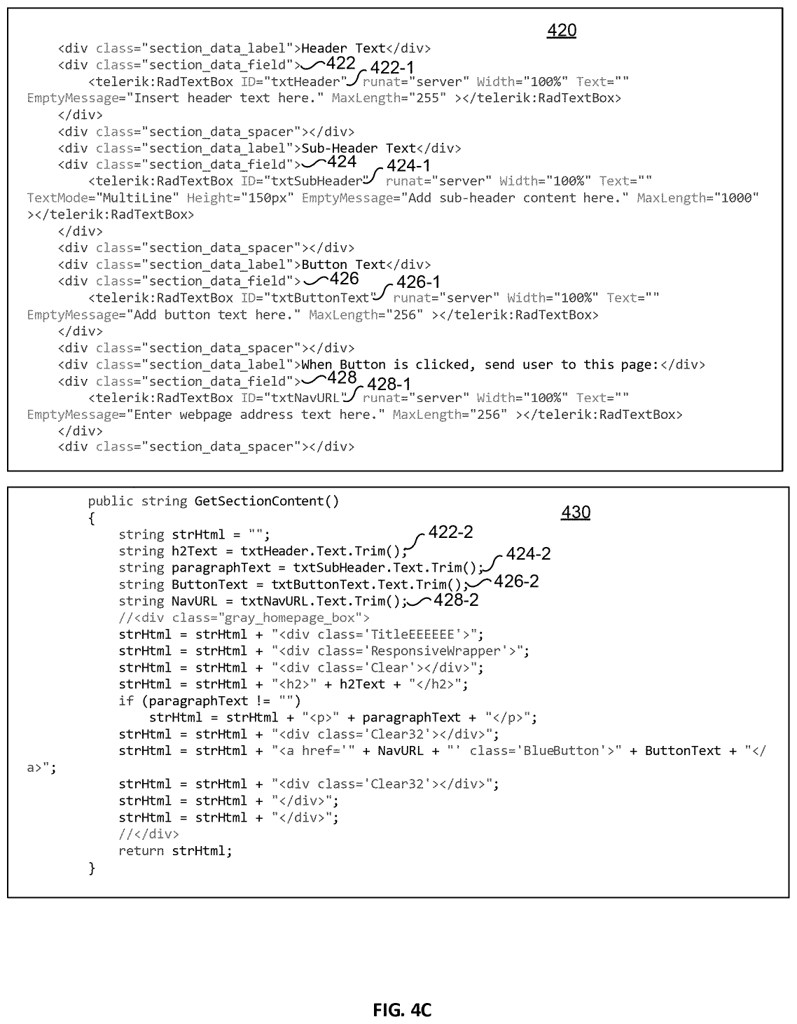

As shown in the diagram 400 of FIG. 4A, the Section Rendering Engine displays a user interface for editing fields of a selected representation of a different header webpage section. The user interface is displayed in response to user selection of an edit page section functionality 402. The user interface includes a header text field 404 in which the user can input header text. The user interface includes a paragraph text field 406 in which the user can input paragraph text 406. The user interface includes a button text field 408 at which the user can provide text that will be displayed within a selectable button functionality in the rendered header webpage section. The user interface further includes a sound field 410 at which allows the user to select a reference to a sound file that includes a type of sound to be played in response to selection of the rendered button functionality. The Section Rendering Engine captures the input text and the sound file reference and the Section Rendering Engine inserts the input text and the sound file reference into one or more portions of header webpage section code of a pre-defined object for the different header webpage section. The user interface includes a see section mockup functionality 412 that, upon selection, provides the user with a preview of a rendered version of the different header webpage section.

As shown in the diagram 414 of FIG. 4B, the Section Rendering Engine displays a user interface that includes a preview of a rendered version of the different header webpage section. The user interface is displayed in response to user selection of the see section mockup functionality 412 or a view page section functionality 416. Upon receipt of user selection of an add section functionality 418, the Section Rendering Engine generates an account section data record for the different header webpage section and links the different header webpage section's data record to the user's account webpage data record.

As shown in FIG. 4C, the Section Rendering Engine implements section editing code 420 for the section template editing user interface illustrated by FIG. 4A. For example, the section editing code 420 includes one or more code portions 422, 424, 426, 428 for a pre-defined object that defines user-provided input to be included in a webpage header section. A code portion 422 represents a <div class> code portion at which the user will input header text and a code portion 422-1 represents an identifier for the user provided header text. Another code portion 424 represents a <div class> code portion at which the user will input sub-header text and a code portion 424-1 represents an identifier for the user provided sub-header text. Another code portion 426 represents a <div class> code portion at which the user provides button text and a code portion 426-1 represents an identifier for the user provided button text. The user will insert a navigation links or address (such as a URL) at a <div class> code portion 428 and a code portion 428-1 represents an identifier for that inserted navigation link. The Section Rendering Engine extracts the code portions 422, 422-1, 424, 424-1, 426, 426-1, 428, 428-1 and stores the extracted code portions in a corresponding account webpage section data record.

As shown in FIG. 4C, the Section Rendering Engine implements rendering code 430 for the section rendering user interface illustrated by FIG. 4B. For example, Section Rendering Engine pulls the stores the extracted code portions 422, 422-1, 424, 424-1, 426, 426-1, 428, 428-1 from the corresponding account webpage section data record in order to render the header section via the rendering code 430. The Section Rendering Engine inserts the stored code portions via variables 422-2, 424-2, 426-2, 428-2 of the rendering code 430 in order to render the header section according to the user input.

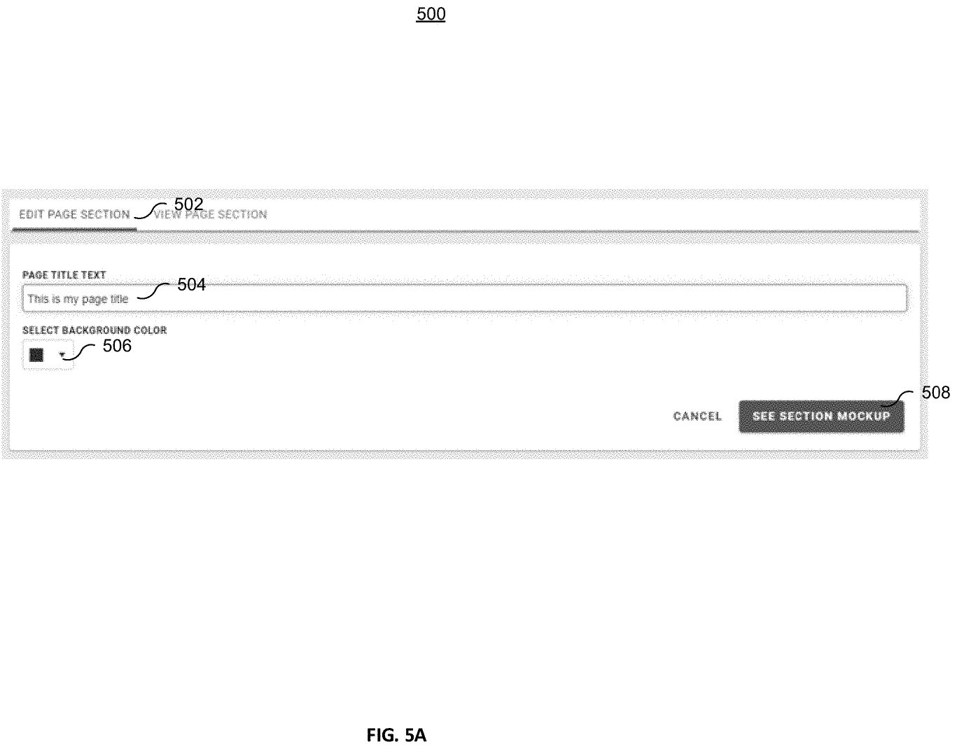

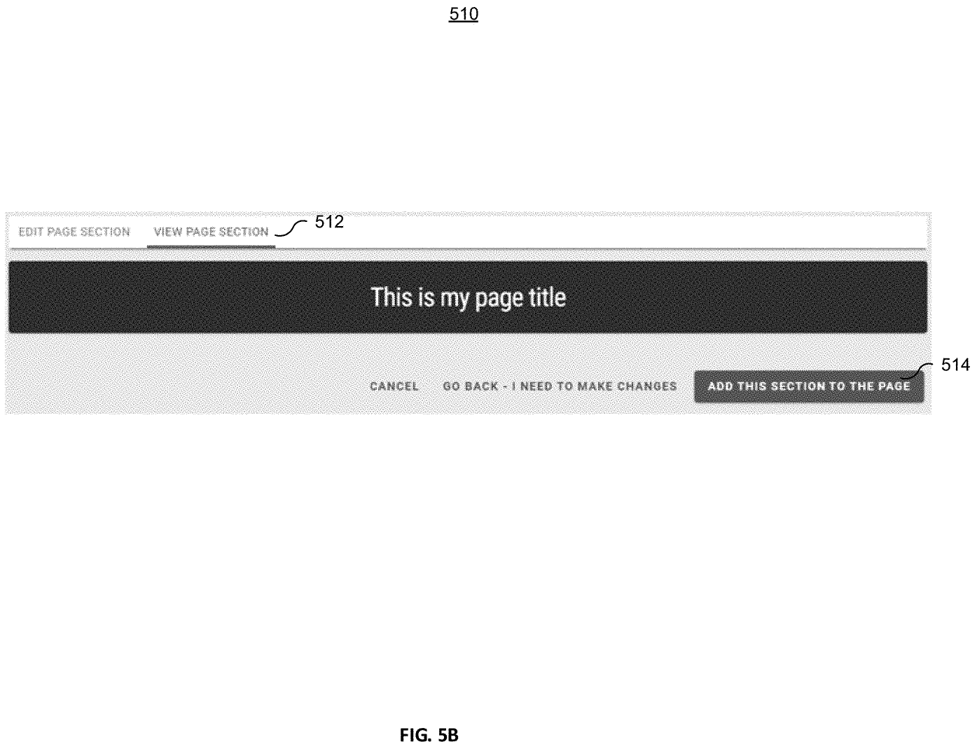

As shown in the diagram 500 of FIG. 5A, the Section Rendering Engine displays a user interface for editing fields of a selected representation of a title webpage section. The user interface is displayed in response to user selection of an edit page section functionality 502. The user interface includes a title text field 504 in which the user can input title text. The user interface includes a color selection functionality 506 at which the user specifies a color (such as black) for the rendered title section. The Section Rendering Engine captures the input text and the specified color and the Section Rendering Engine inserts the input text and a specified color reference into one or more portions of title webpage section code of a pre-defined object for the title webpage section. The user interface includes a see section mockup functionality 508 that, upon selection, provides the user with a preview of a rendered version of the title webpage section.

As shown in the diagram 510 of FIG. 5B, the Section Rendering Engine displays a user interface that includes a preview of a rendered version of the title webpage section. The user interface is displayed in response to user selection of the see section mockup functionality 508 or a view page section functionality 512. Upon receipt of user selection of an add section functionality 514, the Section Rendering Engine generates an account section data record for the title webpage section and links the title webpage section's data record to the user's account webpage data record.

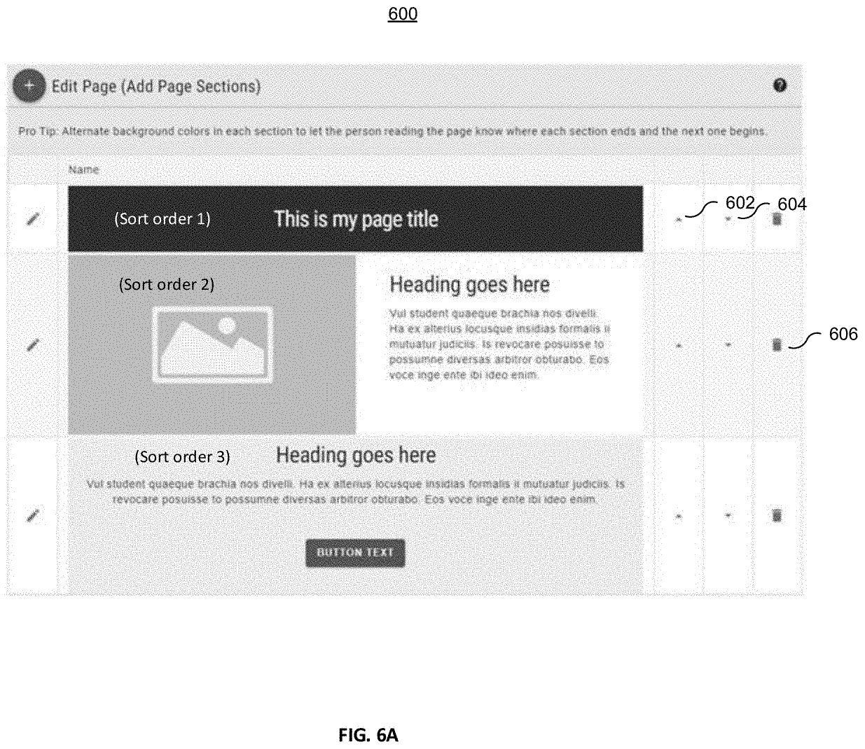

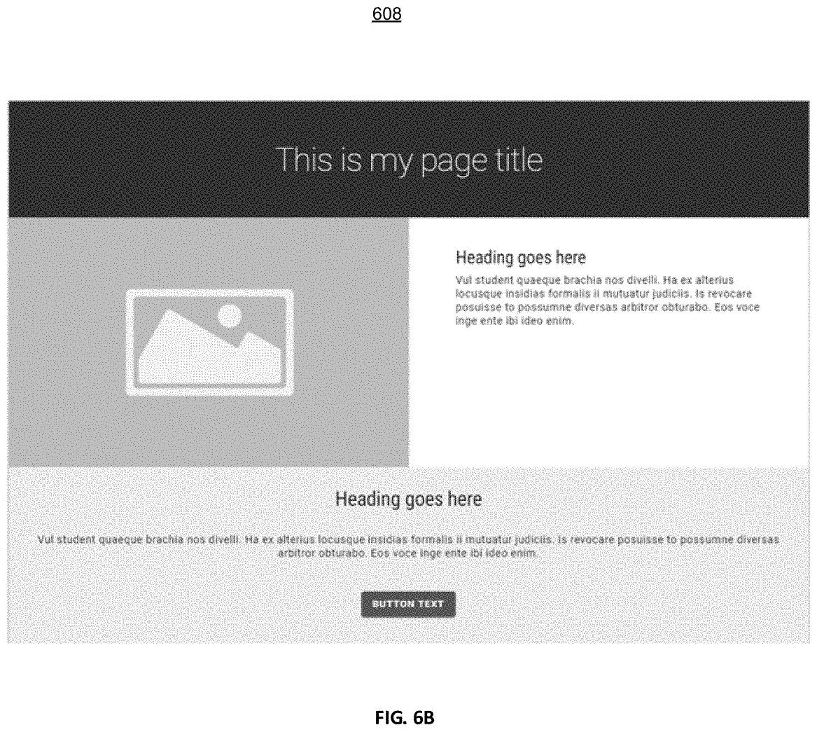

As shown in the diagram 600 of FIG. 6A, the Section Rendering Engine displays a user interface that presents rendered thumbnails of webpage section data records linked to the user's account webpage data record. The rendered thumbnails are presented according to their respective sort orders, where each rendered thumbnail's sort order corresponds to a particular display position in the same webpage. Display of each rendered thumbnail includes corresponding functionality 602, 604 for rearranging a section display location and thereby updating a sort order filed in a webpage section data record. For example, the user may select to increase the sort order by selecting the increase sort order functionality 604 such that display of the title section moves from a sort order 1 position to a sort order 2 position. In response to the update to the title section's sort order, the Section Rendering Engine may adjust the sort order of the header section or the different header section to be the sort order 1 position. In addition, display of each rendered thumbnail further includes a corresponding delete functionality 606 that allows the user to select a respective section to be removed from the rendering of the webpage.

As shown in the diagram 608 of FIG. 6B, a user interface displays a webpage rendered according to respective webpage section templates selected by the user via Section Rendering Engine.

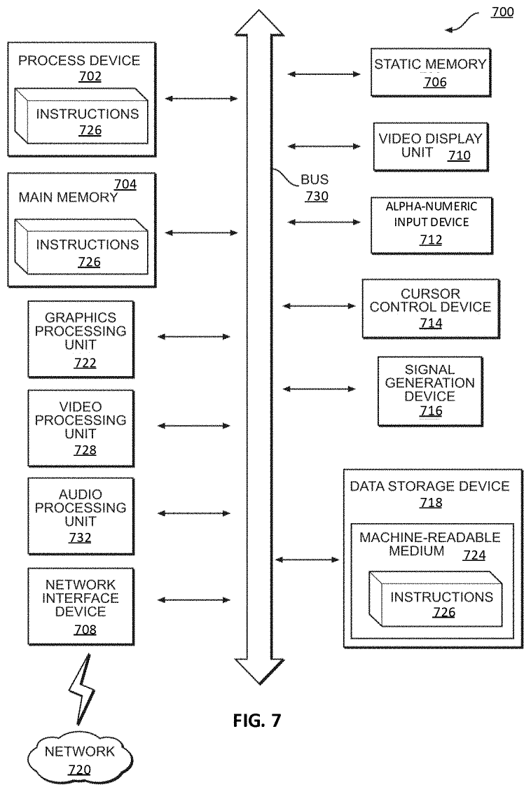

FIG. 7 illustrates an example machine of a computer system within which a set of instructions, for causing the machine to perform any one or more of the methodologies discussed herein, may be executed. In alternative implementations, the machine may be connected (e.g., networked) to other machines in a LAN, an intranet, an extranet, and/or the Internet. The machine may operate in the capacity of a server or a client machine in client-server network environment, as a peer machine in a peer-to-peer (or distributed) network environment, or as a server or a client machine in a cloud computing infrastructure or environment.

The machine may be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 700 includes a processing device 702, a main memory 704 (e.g., read-only memory (ROM), flash memory, dynamic random access memory (DRAM) such as synchronous DRAM (SDRAM) or Rambus DRAM (RDRAM), etc.), a static memory 706 (e.g., flash memory, static random access memory (SRAM), etc.), and a data storage device 718, which communicate with each other via a bus 730.

Processing device 702 represents one or more general-purpose processing devices such as a microprocessor, a central processing unit, or the like. More particularly, the processing device may be complex instruction set computing (CISC) microprocessor, reduced instruction set computing (RISC) microprocessor, very long instruction word (VLIW) microprocessor, or processor implementing other instruction sets, or processors implementing a combination of instruction sets. Processing device 702 may also be one or more special-purpose processing devices such as an application specific integrated circuit (ASIC), a field programmable gate array (FPGA), a digital signal processor (DSP), network processor, or the like. The processing device 702 is configured to execute instructions 726 for performing the operations and steps discussed herein.

The computer system 700 may further include a network interface device 708 to communicate over the network 720. The computer system 700 also may include a video display unit 710 (e.g., a liquid crystal display (LCD) or a cathode ray tube (CRT)), an alphanumeric input device 712 (e.g., a keyboard), a cursor control device 714 (e.g., a mouse), a graphics processing unit 722, a signal generation device 716 (e.g., a speaker), graphics processing unit 722, video processing unit 728, and audio processing unit 732.

The data storage device 718 may include a machine-readable storage medium 724 (also known as a computer-readable medium) on which is stored one or more sets of instructions or software 726 embodying any one or more of the methodologies or functions described herein. The instructions 726 may also reside, completely or at least partially, within the main memory 704 and/or within the processing device 702 during execution thereof by the computer system 700, the main memory 704 and the processing device 702 also constituting machine-readable storage media.

In one implementation, the instructions 726 include instructions to implement functionality corresponding to the components of a device to perform the disclosure herein. While the machine-readable storage medium 724 is shown in an example implementation to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “identifying” or “determining” or “executing” or “performing” or “collecting” or “creating” or “sending” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus may be specially constructed for the intended purposes, or it may comprise a general-purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

Various general-purpose systems may be used with programs in accordance with the teachings herein, or it may prove convenient to construct a more specialized apparatus to perform the method. The structure for a variety of these systems will appear as set forth in the description above. In addition, the present disclosure is not described with reference to any particular programming language. It will be appreciated that a variety of programming languages may be used to implement the teachings of the disclosure as described herein.

The present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form readable by a machine (e.g., a computer). For example, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing disclosure, implementations of the disclosure have been described with reference to specific example implementations thereof. It will be evident that various modifications may be made thereto without departing from the broader spirit and scope of implementations of the disclosure as set forth in the following claims. The disclosure and drawings are, accordingly, to be regarded in an illustrative sense rather than a restrictive sense.

What is claimed is:

1. A computer-implemented method, comprising:
presenting to a user a plurality of selectable representations of one or more webpage section templates;
receiving from the user a selected representation of a desired webpage section template; and
dynamically rendering a portion of the webpage based on the desired webpage section template.

2. The computer-implemented method of claim 1,
in response to receiving from the user a selected representation of a desired webpage section template, presenting to the user a corresponding section editing user interface;
receiving user input at one or more fields of the section editing user interface;
extracting one or more code sections and associated user input of the user editing interface;
storing the one or more code section and associated user input in a webpage section data record, the webpage section data record further including a sort order field value selected by the user;
linking the webpage section data to a webpage account data record associated with the user;
wherein dynamically rendering a portion of the webpage based on the desired webpage section template comprises:
accessing the webpage account data record associated with the user in response to a request to access the webpage;
sequentially accessing a plurality of webpage section data records according to a respective sort order field value of each webpage section data record;
for each accessed webpage section data record:
retrieving one or more code sections and associated user input;
inserting the retrieved code sections and associated user input to one or more portions of webpage section rendering code; and
executing webpage section rendering code to render the corresponding webpage section at a user interface display location related to the sort order field value of the accessed webpage section data record.

3. The computer-implemented method of claim 1, further comprising:
in response to receiving the selected representation of a desired webpage section template, generating an account section data record for the desired webpage section template; and
linking the generated account section data record to an account webpage data record;
wherein the selected representation of the desired webpage section template is independent of a pre-defined webpage template, wherein each respective webpage section template is associated with a corresponding pre-defined object that includes webpage section code.

4. The computer-implemented method of claim 3, wherein the account section data record includes a section title field, a sort order field and webpage section code that corresponds to the desired webpage section template.

5. The computer-implemented method of claim 4, wherein the sort order field includes a value that indicates a display placement of the rendered desired webpage section template with respect to one or more concurrently displayed additional rendered webpage section templates.

6. The computer-implemented method of claim 4, wherein each respective additional rendered webpage section template is associated with a corresponding account section data record linked to the same account webpage data record.

7. The computer-implemented method of claim 3, wherein dynamically rendering a portion of the webpage based on the desired webpage section template comprises:
receiving a request to access a webpage defined according to the account webpage data record;
rendering the webpage section code of the account section data record for the desired webpage section template; and
displaying the rendered webpage section code at a portion of the rendered webpage that is defined by the value of the sort order field in the account section data record for the desired webpage section template.

8. A system comprising one or more processors, and a non-transitory computer-readable medium including one or more sequences of instructions that, when executed by the one or more processors, cause the system to perform operations comprising:
presenting to a user a plurality of selectable representations of one or more webpage section templates;
receiving from the user a selected representation of a desired webpage section template; and
dynamically rendering a portion of the webpage based on the desired webpage section template.

9. The system of claim 8, further comprising:
in response to receiving from the user a selected representation of a desired webpage section template, presenting to the user a corresponding section editing user interface;
receiving user input at one or more fields of the section editing user interface;
extracting one or more code sections and associated user input of the user editing interface;
storing the one or more code section and associated user input in a webpage section data record, the webpage section data record further including a sort order field value selected by the user;
linking the webpage section data to a webpage account data record associated with the user;
wherein dynamically rendering a portion of the webpage based on the desired webpage section template comprises:
accessing the webpage account data record associated with the user in response to a request to access the webpage;
sequentially accessing a plurality of webpage section data records according to a respective sort order field value of each webpage section data record;
for each accessed webpage section data record:
retrieving one or more code sections and associated user input;
inserting the retrieved code sections and associated user input to one or more portions of webpage section rendering code; and
executing webpage section rendering code to render the corresponding webpage section at a user interface display location related to the sort order field value of the accessed webpage section data record.

10. The system of claim 8, further comprising:
in response to receiving the selected representation of a desired webpage section template,
generating an account section data record for the desired webpage section template; and
linking the generated account section data record to an account webpage data record wherein the selected representation of the desired webpage section template is independent of a pre-defined webpage template, wherein each respective webpage section template is associated with a corresponding pre-defined object that includes webpage section code.

11. The system of claim 10, wherein the account section data record includes a section title field, a sort order field and webpage section code that corresponds to the desired webpage section template.

12. The system of claim 11, wherein the sort order field includes a value that indicates a display placement of the rendered desired webpage section template with respect to one or more concurrently displayed additional rendered webpage section templates.

13. The system of claim 11, wherein each respective additional rendered webpage section template is associated with a corresponding account section data record linked to the same account webpage data record.

14. The system of claim 10, wherein dynamically rendering a portion of the webpage based on the desired webpage section template comprises:
receiving a request to access a webpage defined according to the account webpage data record;
rendering the webpage section code of the account section data record for the desired webpage section template; and
displaying the rendered webpage section code at a portion of the rendered webpage that is defined by the value of the sort order field in the account section data record for the desired webpage section template.

15. A computer program product comprising a non-transitory computer-readable medium having a computer-readable program code embodied therein to be executed by one or more processors, the program code including instructions for:
presenting to a user a plurality of selectable representations of one or more webpage section templates;
receiving from the user a selected representation of a desired webpage section template; and
dynamically rendering a portion of the webpage based on the desired webpage section template.

16. The computer program product of claim 15, further comprising:
in response to receiving from the user a selected representation of a desired webpage section template, presenting to the user a corresponding section editing user interface;
receiving user input at one or more fields of the section editing user interface;
extracting one or more code sections and associated user input of the user editing interface;
storing the one or more code section and associated user input in a webpage section data record, the webpage section data record further including a sort order field value selected by the user;
linking the webpage section data to a webpage account data record associated with the user;
wherein dynamically rendering a portion of the webpage based on the desired webpage section template comprises:
accessing the webpage account data record associated with the user in response to a request to access the webpage;
sequentially accessing a plurality of webpage section data records according to a respective sort order field value of each webpage section data record;
for each accessed webpage section data record:
retrieving one or more code sections and associated user input;
inserting the retrieved code sections and associated user input to one or more portions of webpage section rendering code; and
executing webpage section rendering code to render the corresponding webpage section at a user interface display location related to the sort order field value of the accessed webpage section data record.

17. The computer program product of claim 15, further comprising:
in response to receiving the selected representation of a desired webpage section template,
generating an account section data record for the desired webpage section template; and
linking the generated account section data record to an account webpage data record
wherein the selected representation of the desired webpage section template is independent of a pre-defined webpage template, wherein each respective webpage section template is associated with a corresponding pre-defined object that includes webpage section code.

18. The computer program product of claim 17, wherein the account section data record includes a section title field, a sort order field and webpage section code that corresponds to the desired webpage section template.

19. The computer program product of claim 18, wherein the sort order field includes a value that indicates a display placement of the rendered desired webpage section template with respect to one or more concurrently displayed additional rendered webpage section templates; and
wherein each respective additional rendered webpage section template is associated with a corresponding account section data record linked to the same account webpage data record.

20. The computer program product of claim 17, wherein dynamically rendering a portion of the webpage based on the desired webpage section template comprises:
receiving a request to access a webpage defined according to the account webpage data record;
rendering the webpage section code of the account section data record for the desired webpage section template; and
displaying the rendered webpage section code at a portion of the rendered webpage that is defined by the value of the sort order field in the account section data record for the desired webpage section template.
